(19) United States
(12) Patent Application Publication
(10) Pub. No.: US 2020/0207633 A1
(43) Pub. Date: Jul. 2, 2020

(54) METHOD AND DEVICE FOR ACCELERATING EVAPORATION OF BRINE IN PLATEAU SALT LAKE

(71) Applicants: Binyuan Zhu, Guangzhou (CN); Guangzhou Ruishi Tianqi Energy Technology Co., Ltd., Guangzhou (CN); Tibet Ruishi Tianqi Salt Lake Technology Co., Ltd., Lhasa (CN)

(72) Inventors: Binyuan Zhu, Guangzhou (CN); Hao Yu, Guangzhou (CN); Xiong Zeng, Guangzhou (CN)

(73) Assignees: Guangzhou Ruishi Tianqi Energy Technology Co., Ltd., Guangzhou (CN); Tibet Ruishi Tianqi Salt Lake Technology Co., Ltd., Lhasa (CN); Binyuan Zhu, Guangzhou (CN)

(21) Appl. No.: 16/615,935

(22) PCT Filed: May 24, 2018
(86) PCT No.: PCT/CN2018/088212

§ 371 Date: Nov. 22, 2019

(30) Foreign Application Priority Data
May 26, 2017 (CN) 201710385790.3
Oct. 13, 2017 (CN) 201710951749.8

(51) Int. Cl. C01D 3/06

(52) U.S. Cl. CPC C01D 3/06

(57) ABSTRACT

A method for accelerating evaporation of brine in plateau salt lakes includes introducing downward wind to a brine surface; and changing the downward wind to transversal wind horizontally flowing outward when the wind contacts with the brine surface, to accelerate evaporation of the brine. Said method is simple in operation, can accelerate the evaporation of the brine, and can realize industrialized brine production at low cost. It is less prone to form salt deposits in concentrated brine, and is also easy to separate salt crystals precipitated from brine. Said device has a simple and reliable structure; low costs for the manufacture, use, and maintenance thereof; and improved evaporation of brine. Said device is convenient to be used in plateau salt-lake regions and easy to be relocated and with a minimal contact area with brine, it is essentially impossible to form salts deposits on the surface of the device.

### CROSS-REFERENCE TO RELATED APPLICATIONS

This application is the national stage of International Application No. PCT/CN2018/088212 filed May 24, 2018, which is based upon and claims priority to Chinese Patent Application Nos. 2017103857903 filed on May 26, 2017 and 2017109517498 filed on Oct. 13, 2017, the entire contents of which are incorporated herein by reference.

### TECHNICAL FIELD

The present disclosure relates to a method for accelerating the evaporation of brine of plateau salt lakes, as well as a device for the same.

### BACKGROUND ART

There are many resource-rich salt lakes in plateau regions. However, such regions with salt lakes usually have harsh natural conditions and weak industrial bases. The existing mining technologies are mainly based on solar salt processes, which means concentrate brine from the salt lakes by means of natural conditions such as sunlight exposure and wind blowing in the plateau regions. Such mining technologies require salt ponds with good leakage-preventing effect and heat preservation measures. These salt ponds with complicated structures are difficult to construct. In addition, the service life of the leakage-preventing layers of the salt ponds are relative short, thus the construction cost of salt ponds is high.

During the processes of solar salt, brine preparation and concentration, the temperature of brine changes frequently, which would cause a large amount of salts to be precipitated with some other mineral elements. Due to a long period of brine concentration, the precipitated salts cannot be separated in time, and would form a blocky salt layer at the bottom of the salt ponds. Because of the disturbance of the mineral elements precipitated with salts, the mining of the blocky salt layer would be more difficult, the process would be extended and the efficiency would be reduced, resulting in the substantial waste of resources and affect the comprehensive development and utilization of other mineral elements. In addition, the salt hardening can greatly shorten the service life of the salt ponds, accelerate the scrap of the salt ponds and increase solar salt cost.

During the preparation of brine according to traditional solar salt processes, a large amount of water will be evaporated, and the evaporated water cannot be recovered. If things go on like this, the water balance in the salt lake regions will be broken and make the water level drop, which may cause irreversible impact on local ecological environment. With stricter requirement of environmental protection, the requirements for the mining of the salt lakes is higher, the sustainable or protective mining of salt lakes receives more and more attention.

There is great practical significance to develop a method for evaporating brine with lower cost and faster evaporation, and a device for the same.

### SUMMARY

The present invention is intended to overcome at least one defect of the prior art, and to provide an industrially implementable method for accelerating the evaporation of brine in plateau salt lakes, and a device for the same.

The technical solutions adopted in the present disclosure may be as follows.

According to one aspect of the present disclosure, a method for accelerating the evaporation of brine in a plateau salt lake may be provided and may comprise: introducing downward wind to a brine surface; changing the wind to horizontally flow outward when the wind contacts with the brine surface, to accelerate evaporation of brine.

According to some embodiments of the above method, an angle formed by the downward wind and the brine surface may range from 45° to 90°. Preferably, the angle formed by the downward wind and the brine surface may range from 60° to 90°.

According to some embodiments of the above method, the downward wind may have a speed not lower than 3 m/s, preferably not lower than 4 m/s, more preferably have speed from 5 m/s to 15 m/s.

According to some embodiments of the above method, the method may comprise a step of collecting exchanged wind for water-collecting treatment.

According to some embodiments of the above method, a wind deflector may be arranged above the brine surface to collect the exchanged wind for the water-collecting treatment.

According to a second aspect of the present disclosure, a device for accelerating evaporation of brine may comprise a support provided with a downward wind outlet.

According to some embodiments of the above device, the support may be further provided with a wind deflector surrounding the downward wind outlet.

According to some embodiments of the above device, the wind deflector may surround the downward wind outlet and form a semi-closed space having an exhaust port.

According to some embodiments of the above device, an exhaust blower may be connected to the exhaust port.

According to some embodiments of the above device, the exhaust blower may be connected with a condenser.

According to some embodiments of the above device, the device may be further provided with a wind guide pipe, and the wind guide pipe may be communicated with the downward wind outlet.

According to some embodiments of the above device, several buoys may be arranged under the support to keep the support floating.

According to some embodiments of the above device, the support may be further provided with an anchor.

According to some embodiments of the above device, the device may be further provided with a heat exchanger for heating the brine and/or wind.

According to a third aspect of the present disclosure, a device for accelerating evaporation of brine may be further provided and may comprise a central wind duct; wherein a flow channel may be gradually-lowered arranged around the central wind duct and be provided with a brine inlet and a brine outlet; wherein a gap for ventilation may be arranged between a flow channel at an upper layer and a flow channel at a lower layer; and wherein a downward wind outlet may be arranged at a side wall of the central wind duct and be provided with a wind baffle which may make wind blow downward to the surrounding flow channel.

According to some embodiments of the above device, the flow channel may be spirally arranged outside the central wind duct. Specifically, the flow channel may be spirally arranged outside the central wind duct in a stepped mode.

According to some embodiments of the above device, the flow channel may be provided with an overflow plate.

According to some embodiments of the above device, the flow channel may be provided with an exhaust device outside.

The present disclosure may have the following advantages.

In the process of the experiments, the inventors were surprised to find that when the wind flowing the water surface parallel changed into downward at the same speed, the evaporation speed of water can be improved significantly. Based on this unexpected discovery, the inventors developed the method for accelerating evaporation of brine, as well as the device for the same.

Some embodiments of the method of the present disclosure are simple in operation, with accelerated evaporation of the salt brine, industrialized brine preparation at low cost, and low unit energy consumption for the brine preparation. Because of faster evaporation of the salt brine, the precipitated salt can be separated in time, so as to avoid the formation of hardened salt deposits or layers. Thus, it can avoid adverse effects brought by salt block deposition. Meanwhile, it can effectively screen other mineral elements which have been precipitated and carried in the salt. It is beneficial for the comprehensive development and utilization of the salt lakes and can greatly reduce the loss of resources. Therefore, the method of the present disclosure is particularly suitable for preparing lithium-containing brine. The method of the present disclosure can realize low cost, environmentally-friend, continuous and industrial brine preparation, and thus substantially rid the salt lake mining of the “relying on the weather” situation.

The present disclosure can accelerate the evaporation of water and improve the efficiency of brine preparation without consuming extra energy, by providing a mechanical structure, such as a wind guide pipe, to change natural wind substantially parallel to the water surface to downward. It is especially suitable for remote salt-lake regions.

Some embodiments of the device of the present disclosure have a simple and reliable structure; low costs for the manufacture, use and maintenance thereof; and improved evaporation of brine. The device of the present disclosure is favorable for use in the plateau salt-lake regions. The device of the present disclosure can be conveniently moved. In addition, the device has an extremely small contact surface with brine, so it is essentially impossible to form salt deposits on the surface of the device. Further, the salt particles precipitated from brine during the concentration process can be discharged easily from the device.

By water-collecting treatment, a large amount of water vapor can be recovered to provide fresh water for subsequent production and life. Meanwhile, it is also convenient to return a part of water to the lake to avoid adverse effects on local ecology of the salt-lake regions, which is beneficial for the sustainable development of the plateau salt lakes.

### BRIEF DESCRIPTION OF THE DRAWINGS

FIG. 1 is a structure schematic diagram of a device according to one embodiment of the present disclosure;

FIG. 2 is a structure schematic diagram illustrating a flow channel unit according to another embodiment of the device of the present disclosure;

FIG. 3 is a structure schematic diagram illustrating a central wind duct unit according to another embodiment of the device of the present disclosure; and

FIG. 4 is an overall structure schematic diagram according to a still another embodiment of the device of the present disclosure.

### DETAILED DESCRIPTION

A method for accelerating the evaporation of brine in plateau salt lakes comprises: introducing downward wind to a brine surface; changing the downward wind to transversal wind horizontally flowing outward when the wind comes into contact with the brine surface, to accelerate evaporation of brine.

The downward wind can be generated not only by a blower, but also by changing the direction of natural wind through a mechanical structure. For example, natural wind can be concentrated by a wind guide pipe, and then be changed to blow downward through a bent pipe.

According to some embodiments of the above method, an angle formed by the downward wind and the brine surface may range from 45° to 90°, preferably range from 60° to 90°, and most preferably be 90°.

According to some embodiments of the above method, exchanged wind may be collected for water-collecting treatment. It can effectively recover water from brine, and can prevent air with excessive humidity, which may affect the evaporation of water, from accumulating above brine. According to some embodiments of the above method, a wind deflector may be arranged above the brine surface to collect the exchanged wind for the water-collecting treatment.

According to some embodiments of the above method, the downward wind may have a speed not lower than 3 m/s, preferably not lower than 4 m/s, and more preferably have a speed from 5 m/s to 15 m/s. If the wind speed is too low, though energy consumption would be relatively low, the evaporation speed would be relatively slow. The higher the wind speed is, the faster the evaporation speed is, and the energy consumption would increase corresponding. When the wind speed exceeds a certain level, the evaporation of brine would reach the limit at this temperature and air humidity. In comprehensive consideration, the downward wind may have a speed not lower than 3 m/s, preferably not lower than 4 m/s, and more preferably have a speed from 5 m/s to 15 m/s or from 5 m/s to 10 m/s. Alternatively, the wind speed can be adjusted according to actual production needs. For example, the wind speed can be increased to accelerate the evaporation of brine and thus obtain qualified brine faster, under the condition of sufficient energy supply.

The drier wind is, the easier brine evaporates. According to some embodiments of the above method, the wind may have a relative humidity not more than 50%.

If the condition permits, the evaporation speed can be further increased by heating the wind and/or brine.

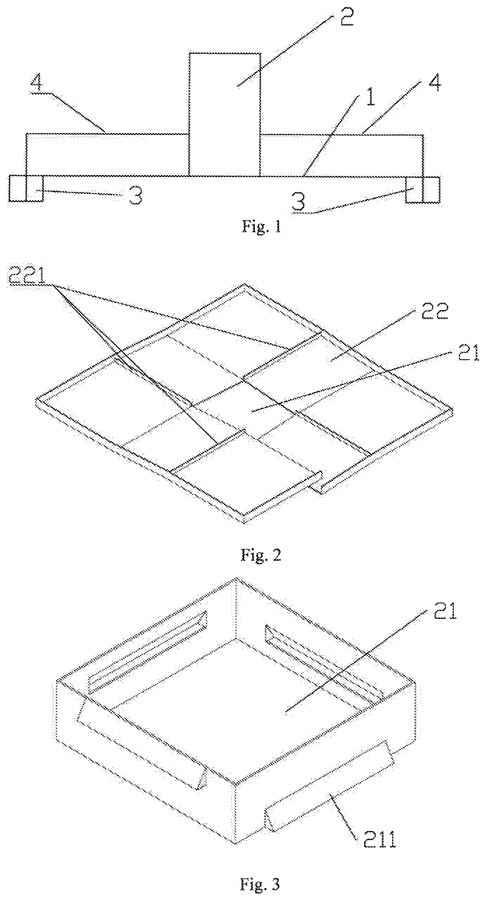

With reference to FIG. 1, it shows a device for accelerating the evaporation of brine, which comprises a support 1 providing with a downward wind outlet 2.

According to some embodiments of the above device, several buoys 3 are arranged under the support to keep the support 1 floating.

According to some embodiments of the above device, the support 1 is further provided with a wind deflector 4 surrounding the downward wind outlet 2.

According to some embodiments of the above device, the wind deflector 4 surrounding the downward wind outlet 2 forms a semi-closed space having an exhaust port.

According to some embodiments of the above device, the exhaust port is connected with a condenser. In this way, it would be convenient to recover water vapor to provide fresh water for subsequent production and life. Meanwhile, it would avoid excessive loss of water into atmosphere in salt-lake regions, which may bring adverse effects on ambient environment.

According to some embodiments of the above device, the support is further provided with an anchor, so as to basically fix the device at a specific position at the water surface.

According to some embodiments of the above device, the exhaust port is provided with an exhaust blower. In this way, it can discharge wet air in the device faster. The exhaust blower can be further combined with the condenser to change vapor into fresh water.

According to some embodiments of the above device, the device is further provided with a heat exchanger for heating brine and/or wind. If the condition permits, the heat exchanger could be used to heat brine and/or air, to further improve the evaporation speed of brine.

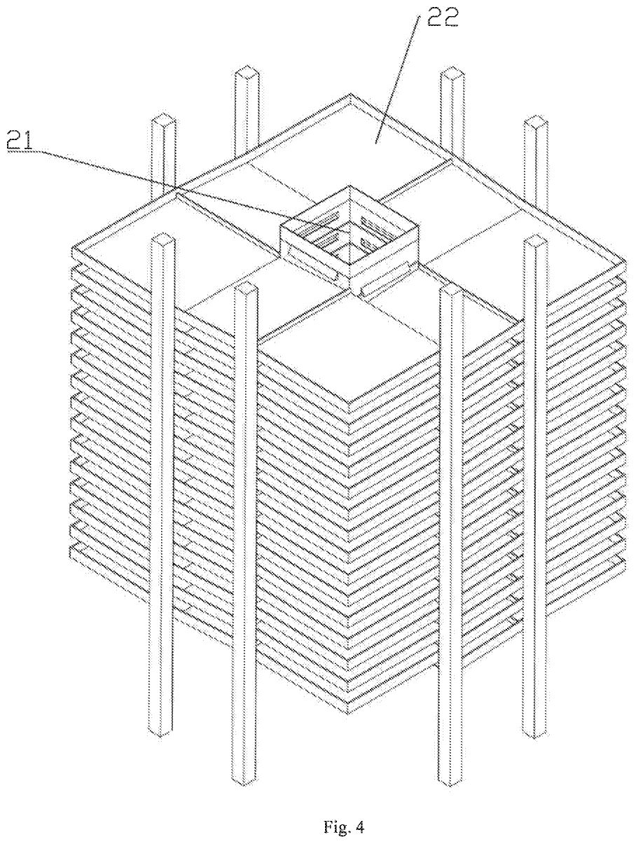

FIGS. 2 to 4 show another device for accelerating evaporation of brine. This device comprises a central wind duct 21. A flow channel 22 is gradually-lowered arranged around the central wind duct 21 and provided with a brine inlet and a brine outlet. In addition, a gap for ventilation is arranged between a flow channel at an upper layer and a flow channel at a lower layer. A downward wind outlet is arranged at the side wall of the central wind duct 21, and is provided with a wind baffle 211 which can make the wind blow downward to the surrounding flow channel.

According to some embodiments of the above device, the flow channel is spirally arranged outside the central wind duct. Specifically, the flow channel is spirally arranged outside the central wind duct in a stepped manner. In this way, water flow can be gentler and is easy to evaporate. The stepped spiral can enable the flow channel to have a fat plane in a local region and further prolong the residence time of the flow, so as to obtain more sufficient evaporation. The spiral flow channel may be of multi-layer spiral, which can effectively improve an effective evaporation area in overall.

According to some embodiments of the above device, the flow channel 22 is provided with an overflow plate 221. The overflow plate 221 can maintain the water level in the flow channel.

According to some embodiments of the above device, the flow channel is provided with an exhaust device outside. In this way, it can discharge wet air in the device faster. The exhaust blower can be further combined with the condenser to cool down vapor into fresh water.

Meanwhile, the brine can be circulated with a circulating pump and evaporated as required, until the requirements are met. Two or more devices can also be used in series or in parallel as required.

Hereinafter, the technical solutions of the present disclosure will be further described in the combination of the following experiments.

In the experiments, speed regulators are used to adjust the power of DC high-speed blowers to generate wind of different speeds. Since the DC power supply and the speed regulators consume a part of power, the actual power of the blower would be 2 W, 7.7 W, 14.6 W and 27 W respectively, if the total power of a system is actually measured to be 10 W, 20 W, 30 W and 40 W respectively. Table 1 shows the speeds of the wind generated by the blowers of different power. In the experiments, the distance between the blower and the liquid surface ranges from 10 cm to 12 cm.

In practical application, it can select a blower of appropriate power to work at full load, such that the speed regulator can be saved, the average loss of the DC power supply can be reduced, and the power of the system can be consistent with that of the blower.

TABLE 1
Comparison Table of Blower Power and Wind Speed

| | Distance | | | | | | | |
|---|---|---|---|---|---|---|---|---|
| | 2 W | | 7.7 W | | 14.6 W | | 27 W | |
| | Wind | Wind | Wind | Wind | Wind | Wind | Wind | Wind |
| | speed | speed | speed | speed | speed | speed | speed | speed |
| | 1 | 2 | 1 | 2 | 1 | 2 | 1 | 2 |
| cm | m/s | m/s | m/s | m/s | m/s | m/s | m/s | m/s |
| 0 | 4.9 | 5.5 | 8.2 | 9.5 | 10.5 | 12.2 | 13 | 14 |
| 5 | 4.2 | 4.0 | 7.0 | 6.8 | 8.8 | 8.2 | 11.5 | 10.3 |
| 10 | 3.8 | 3.6 | 6.6 | 6.2 | 8 | 7.6 | 10.5 | 9.6 |
| 15 | 3.5 | 3.2 | 6.0 | 5.7 | 7.4 | 7.0 | 9.0 | 8.7 |
| 20 | 3.0 | 3.0 | 5.3 | 5.3 | 6.5 | 6.3 | 7.8 | 7.7 |
| 30 | 2.5 | 2.5 | 4.5 | 4.5 | 5.4 | 5.3 | 6.7 | 6.5 |

Note:
the downward wind outlet of the blower has a diameter of 12 cm, the air-vent of the measuring apparatus for wind speed 1 has a diameter of 6.5 cm, and the air-vent of the measuring apparatus for wind speed 2 has a diameter of 2.5 cm.

### Example 1: Evaporation Experiments with Different Evaporation Areas

Table 2 illustrates the concentration experiments according to the method and device of the present disclosure in different regions and with different evaporation areas. Liquid evaporated in the experiments is fresh water, the blower has the power of 7.7 W, and the angle formed by the inlet wind and the liquid surface is 90°.

TABLE 2
Evaporation Experiments with Different Evaporation Areas

| | | Evaporation | Air | Air | Liquid | Experiment | Evaporation | | Evaporation energy |
|---|---|---|---|---|---|---|---|---|---|
| Experiment | Experiment | area | temperature | humidity | temperature | time | speed | | consumption |
| site | condition | m² | ° C. | % | ° C. | h | mm/h | Kg/h | Kwh/kg |
| Lhasa | Natural wind | 0.25 | 20.7 | 30 | 12.4 | 24 | 0.484 | 0 121 | 0.0636 |
| | (transversal | | | | | | | | |
| | wind) | | | | | | | | |
| | The present | | 20.7 | 30 | 12.0 | 24 | 0.600 | 0.15 | 0.0513 |
| | disclosure | | | | | | | | |
| Guangzhou | Natural wind | 0.35 | 32.0 | 33 | 22.2 | 24 | 0.523 | 0.183 | 0.0421 |
| | (transversal | | | | | | | | |
| | wind) | | | | | | | | |
| | The present | | 32.0 | 33 | 21.8 | 24 | 0.691 | 0.242 | 0.0318 |
| | disclosure | | | | | | | | |
| Lhasa | Natural wind | 0.85 | 21.2 | 33 | 14.4 | 24 | 0.375 | 0.319 | 0.0241 |
| | (transversal | | | | | | | | |
| | wind) | | | | | | | | |
| | The present | | 21.5 | 33 | 13.4 | 24 | 0.500 | 0.425 | 0.0181 |
| | disclosure | | | | | | | | |
| Guangzhou | Natural wind | 2.4 | 31.6 | 35 | 23.0 | 48 | 0.292 | 0.701 | 0.0110 |
| | (transversal | | | | | | | | |
| | wind) | | | | | | | | |
| | The present | | 31.2 | 36 | 22.6 | 48 | 0.417 | 1.001 | 0.0077 |
| | disclosure | | | | | | | | |

Note:
for the experiments with evaporation areas of 0.25 and 0.35 m², the liquid evaporation processes are monitored by weight changes; and for the experiments with evaporation areas of 0.85 and 2.4 m², the liquid evaporation processes are monitored by the changes in liquid level.

The experiment data shows that, with different evaporation areas, the method or device of the present disclosure has an evaporation rate about 30% faster than that of horizontal wind. That is, the method or device of the present disclosure significantly improves the evaporation efficiency of the liquid, and reduces the evaporation energy consumption per unit mass of the liquid. Further, the method or device of the present disclosure can still effectively improve the evaporation efficiency of the liquid, when the evaporation area continuously increases within a certain range. The method or device of the present disclosure can normally and effectively operate in high-altitude regions (e.g. Lhasa), has better evaporation, and is very suitable for the evaporation and concentration of brine in salt lakes.

### Example 2: Influence of Inlet-Wind Angle on Evaporation

Table 3 shows the relationship between different inlet-wind angles and the evaporation of liquid. In the experiments, the evaporated liquid is fresh water, the power of the blower is 7.7 W, and the evaporation area of the equipment is 2.4 m².

TABLE 3
Changes of Evaporation Rates of Liquid with Inlet-Wind Angles

| | Air | Air | Liquid | Experiment | | | Evaporation energy |
|---|---|---|---|---|---|---|---|
| Angle formed by inlet | temperature | humidity | temperature | time | Evaporation speed | | consumption |
| wind and liquid surface | ° C. | % | ° C. | h | rnm/h | Kg/h | Kwh/kg |
| Natural wind (<20°) | 31.6 | 35 | 23.0 | 48 | 0.292 | 0.701 | 0.0110 |
| 45~50° | 31.7 | 35 | 23.4 | 48 | 0.333 | 0.799 | 0.0096 |
| 60~65° | 31.5 | 36 | 23.5 | 48 | 0.354 | 0.850 | 0.0091 |
| 75~80° | 30.0 | 37 | 23.2 | 44 | 0.364 | 0.874 | 0.0088 |
| 90° | 30.8 | 40 | 23.6 | 48 | 0.396 | 0.950 | 0.0081 |

The experiment data shows that the method or device of the present disclosure has the best beneficial effect when the angle between the inlet wind and the liquid surface is 90°. When the inlet-wind angle is gradually reduced to 45°, the evaporation effect of the method or device of the present disclosure is still better than that of natural wind, but the evaporation rate is relatively reduced. Therefore, the preferred inlet-wind angle of the present disclosure ranges from 60° to 90°.

### Example 3: Influence of the Power (Wind Speed) of the Blower on Evaporation Effect

Table 4 shows the evaporation effects produced by the blowers with different power (wind speeds). In the experiments, the evaporated liquid was fresh water, the evaporation area of the device is 2.4 m², and the angle formed by the inlet wind and the liquid surface is 90°.

TABLE 4
Evaporation Effects of Blower with Different Powers

| | Experiment | Blower | Air | Air | Liquid | Experiment | Evaporation | | Evaporation energy |
|---|---|---|---|---|---|---|---|---|---|
| Experiment | No. | power | temperature | humidity | temperature | time | speed | | consumption |
| site | — | W | ° C. | % | ° C. | h | mm/h | Kg/h | Kwh/kg |
| The | 41 | 2 | 31.6 | 38 | 23.9 | 48 | 0.250 | 0.600 | 0.0033 |
| present | | | | | | | | | |
| disclosure | | | | | | | | | |
| Natural | 42 | 7.7 | 31.6 | 35 | 23.0 | 48 | 0.292 | 0.701 | 0.0110 |
| wind | | | | | | | | | |
| (transversal | | | | | | | | | |
| wind) | | | | | | | | | |
| The | 43 | | 31.2 | 36 | 22.6 | 48 | 0.396 | 0.950 | 0.0081 |
| present | | | | | | | | | |
| disclosure | | | | | | | | | |
| Natural | 44 | 14.6 | 31.3 | 36 | 23.5 | 48 | 0.354 | 0.850 | 0.0172 |
| wind | | | | | | | | | |
| (transversal | | | | | | | | | |
| wind) | | | | | | | | | |
| The | 45 | | 31.4 | 37 | 23.3 | 48 | 0.417 | 1.001 | 0.0146 |
| present | | | | | | | | | |
| disclosure | | | | | | | | | |
| Natural | 46 | 27 | 32.1 | 38 | 22.8 | 44 | 0.409 | 0.982 | 0.0275 |
| wind | | | | | | | | | |
| (transversal | | | | | | | | | |
| wind) | | | | | | | | | |
| The | 47 | | 32.1 | 38 | 23.3 | 48 | 0.458 | 1.099 | 0.0246 |
| present | | | | | | | | | |
| disclosure | | | | | | | | | |

This experiment results show that, with different wind speeds, the method or device of the present disclosure can improve the evaporation speeds to a certain extent and reduce the evaporation energy consumption of the liquid. When the wind speed is low (<3 m/s), there is no significant difference between the evaporation of vertical inlet wind and that of horizontal inlet wind, both have low evaporation rates. With the increasing of the wind speed, the present disclosure produces more and more obvious beneficial effect. When the wind speed is high (about 10 m/s), the evaporation rate is also increased with the natural wind, and the evaporation rate of the present disclosure is reduced from 35% higher than that of the natural wind to about 12% higher than that of the natural wind. Meanwhile, the evaporation rate of the liquid is not increased linearly with the wind speed. Although a high wind speed is beneficial for improving the evaporation speed, the evaporation energy consumption would be increased correspondingly. Therefore, the method of the present disclosure may use downward wind which has a wind speed not less than 3 m/s, preferably not less than 4 m/s, and more preferably has a wind speed from 5 m/s to 15 m/s and from 5 m/s to 10 m/s.

### Example 4: Influence of Air Temperature and Humidity on Evaporation Effect

Table 5 shows the evaporation effects of liquid with different air temperatures and humidity. In the experiments, the evaporated liquid is fresh water, the evaporation area of the device is 0.353 m², and the angle formed by the inlet wind and the liquid surface is 90°.

TABLE 5
Evaporation Effects of Liquid with Different Air Temperatures and Humidity

| Comparison | Experiment | Blower | Air | Air | Liquid | Evaporation | Blower energy |
|---|---|---|---|---|---|---|---|
| type | No. | power | temperature | humidity | temperature | speed | consumption |
| — | — | W | ° C. | % | ° C. | Kg/h | Kwh/kg |
| Change of | 51 | 2 | 30 | 40 | 23 | 0.135 | 0.0148 |
| blower | 52 | 7.7 | 30 | 37 | 21 | 0.196 | 0.0393 |
| power | 53 | 14.6 | 33 | 37 | 21 | 0.238 | 0.0613 |
| Change of | 51 | 2 | 30 | 40 | 23 | 0.135 | 0.0148 |
| air | 54 | 2 | 30 | 48 | 24 | 0.113 | 0.0177 |
| humidity | 55 | 2 | 28 | 60 | 22 | 0.086 | 0.0233 |
| Change of | 51 | 2 | 30 | 40 | 23 | 0.135 | 0.0148 |
| air | 56 | 2 | 38 | 34 | 27 | 0.258 | 0.0078 |
| temperature | | | | | | | |

The results of experiments 51, 52 and 53 demonstrate the conclusion obtained in Example 3. That is, the higher the blower power is, the faster the evaporation speed of water achieved by the method or device of the present disclosure is. When the blower power reaches a certain level, the evaporation efficiency of water reaches a limit at the temperature. There would be energy waste if the blower power is further increased.

The results of experiments 51, 54 and 55 indicate that the method or device of the present disclosure can produce better effect with the decrease of the air humidity. The plateau regions have very low air humidity. Thus, it is unnecessary to artificially reduce the air humidity, which can further reduce energy consumption required for the evaporation. Therefore, the method or device of the present disclosure has better evaporation effect for practical applications in the plateau regions, and thus is very suitable for evaporation of brine from plateau salt lakes.

The results of experiments 51 and 56 indicate that the method or device of the present disclosure can effectively evaporate water from the liquid at a normal temperature, and can produce more and more obvious effect with the increase of the temperature. In practical applications, brine and/or inlet wind can be heated by means of waste heat and excess heat from factory workshops, which would further improve the evaporation effect.

### Example 5: Evaporation Experiments of Brine

Table 6 shows the differences between the evaporation of brine and that of fresh water. The evaporation area of the experiment device is 0.353 m², and the angle formed by the inlet wind and the liquid surface is 90°.

TABLE 6
Difference between Evaporation of Brine and that of Fresh Water.

| Liquid | Blower | Air | Air | Liquid | Evaporation | Blower energy |
|---|---|---|---|---|---|---|
| type | power | temperature | humidity | temperature | speed | consumption |
| — | W | ° C. | % | ° C. | Kg/h | Kwh/kg |
| Fresh water | 2 | 30 | 40 | 23 | 0.135 | 0.0148 |
| Brine | | 31 | 32 | 27 | 0.095 | 0.0211 |
| Fresh water | 7.7 | 30 | 37 | 21 | 0.196 | 0.0393 |
| Brine | | 34 | 32 | 26 | 0.142 | 0.0542 |
| Fresh water | 14.6 | 33 | 37 | 21 | 0.238 | 0.0613 |
| Brine | | 32 | 32 | 26 | 0.18 | 0.0811 |

The experiment results show that the evaporation of brine needs to consume more energy as compared with the evaporation of fresh water. However, the evaporations of both fresh water and brine have basically the same trend and thus are comparable.

### Example 6: Experiment Results of Another Evaporation Device in a Low-Altitude Region

In Example 6, the experiments were performed in a low-altitude region (Guangzhou).

The evaporation device has a basic structure as shown in FIGS. 2 to 4. The device has sectional area of 60 cm×60 cm, and a central wind duct in a size of 12 cm×12 cm. Each layer has four downward wind outlets. Liquid flows downward along a water channel in a stepped mode. The device has an interlayer spacing of 3.2 cm, and has 17 layers in total. The overflow plate has a height of 8 mm, and the flow channel plate has a height of 16 mm. The blower is used to supply wind downward through the central wind duct. The device has a cross-sectional area of about 0.345 m² and a total area of about 5.87 m².

The circulating water pump has power of 7 W and a flow rate of 1000 L/h. The experiment device has small cross-sectional area and a few number of layers. In view of this, the water pump cannot fully exert its function. Thus, only the energy consumption of the blower is used for the calculation of the energy consumption, without considering the power consumption of the water pump temporarily. In practical applications, the cross-sectional area and the number of layers of production equipment would be greatly increased. Brine can be centrally pumped into a buffer container with a certain height and supplied to several production devices through a flow controller, thereby greatly reducing the circulation times of brine. The power consumption of the water pump can be controlled below 1% of the power consumption of the blower, and thus can be ignored.

The experiment results re shown in Table 7.

TABLE 7
Results of Evaporation Experiments performed by Another Device.

| | Experiment | Blower | Environment | Environment | Experiment | Liquid | Evaporation | Blower energy |
|---|---|---|---|---|---|---|---|---|
| Liquid | No. | power | temperature | humidity | time | temperature | speed | consumption |
| type | — | W | ° C. | RH % | h | ° C. | Kg/h | Kwh/kg |
| Fresh water | 71 | 0 | 21 | 48 | 24 | 17 | 0.686 | 0 |
| | 72 | 27 | 20 | 57 | 24 | 17 | 1.046 | 0.026 |
| | 73 | 0 | 30 | 44 | 20 | 24 | 1.039 | 0 |
| | 74 | 27 | 31 | 53 | 22 | 25 | 1.535 | 0.018 |
| Brine | 75 | 0 | 32 | 33 | 24 | 27 | 0.625 | 0 |
| | 76 | 7.7 | 32 | 33 | 12 | 27 | 0.917 | 0.008 |
| | 77 | 27 | 32 | 43 | 15 | 27 | 1.018 | 0.027 |

The evaporation rates in experiments 72 and 74 are 1.046 kg/h and 1.535 kg/h, which are respectively 0.36 kg/h and 0.496 kg/h higher than those of experiments 71 and 73 (i.e. 0.686 kg/h and 1.039 kg/h respectively). The evaporation rates in experiments 72 and 74 are increased by 52% and 47%. It demonstrates that the method of the present disclosure is still effective by means of the device and can greatly improve the evaporation efficiency of liquid.

As compared with experiment 75, the results of Experiments 76 and 77 indicate that the device can also accelerate the evaporation of brine. When the ambient temperature is 32° C. and relative humidity is 33%, the evaporation rate of brine can reach to 0.917 kg/h, while the energy consumption of the blower is only 0.008 kwh/kg. Thus, the device of the present disclosure can have great potential in industrial applications and a promising prospect.

During the operation of the device, the evaporation of liquid is influenced by ambient temperature, humidity, liquid temperature and blower power in the same pattern as that in Examples 1 to 5 of the present disclosure. It indicates that the method of the present disclosure is widely applicable.

The evaporation rate of experiment 74 is 1.535 kg/h, which is 1.4 times of that (i.e. 1.099 kg/h) in experiment 47. The device has an area of 2.4 m² as used in experiment 47. While, the device has a cross-sectional area of only 0.36 m² as used in experiment 74, and can produce effect equivalent to that of the aforesaid device applied on an evaporation area of 3.35 m². Thus, the device of the disclosure can have effectively reduced occupied area, and be very suitable for industrial production.

### Example 7: Experiment Results of the Evaporation Device in a Low-Altitude Region

The experiments were performed in a low-altitude region (Guangzhou) in the Example 7.

The evaporation device had a structure similar to that of Example 6. However, the device of Example 7 differed from that of Example 6 in that, for the device of Example 7, the sectional area was of 38.5 cm×38.5 cm, the central wind duct had a size of 12.1 cm×12.1 cm, each layer had four downward wind outlets, liquid flowed downward along a water channel in a stepped mode, the interlayer spacing was of 3.2 cm, and the device had 16 layers in total. The overflow plate had a height of 8 mm, and the flow channel plate had a height of 20 mm. The blower was used to supply wind downward through the central wind duct. The evaporation device was integrally formed by 3D printing technology, and had a cross-sectional area of about 0.13 m² and a total area about 2.08 m².

The device was used to simulate the evaporation experiment of fresh water. The experiment results are shown in

TABLE 8
Example 8. Experiment Results of Evaporation Device in a Low-altitude Region.

| Experiment | Blower | Environment | Environment | Experiment | Liquid | Evaporated | Evaporation | Blower energy |
|---|---|---|---|---|---|---|---|---|
| No. | power | temperature | humidity | time | temperature | weight | speed | consumption |
| — | W | ° C. | RH % | h | ° C. | Kg | Kg/h | Kwh/kg |
| 81 | 0 | 29.8 | 35 | 26 | 24.6 | 1.93 | 0.074 | 0.000 |
| 82 | 7.7 | 29.3 | 39 | 24 | 22.5 | 13.43 | 0.560 | 0.014 |
| 83 | 27 | 29.5 | 45 | 22 | 23.2 | 16.30 | 0.741 | 0.036 |

As compared with Experiment 81, the evaporation rates of fresh water in Experiments 82 and 83 are respectively increased by 7.6 times and 10 times. It indicates that the method and device of the present disclosure can still effectively improve the evaporation efficiency of liquid with different action areas. Further, the method and device of the present disclosure can be further expanded to industrial production.

### Example 8: Evaporation Experiments Performed in a Plateau Region

The experiments were performed in a plateau region (Lhasa) in Example 8.

The evaporation device 1 was the same as that used in Example 6, and the evaporation device 2 had a structure similar to that of Example 6. The differences between the evaporation device 2 and that of Example 6 lied in that the sectional area was of 38.5 cm×38.5 cm, the central wind duct had a size of 12.1 cm×12.1 cm, each layer had four downward wind outlets, liquid flowed downward along a water channel in a stepped mode, the interlayer spacing was of 3.2 cm, and the device had 12 layers in total. The overflow plate had a height of 8 mm, and the flow channel plate had a height of 20 mm. The blower was used to supply wind downward through the central wind duct. The evaporation device 2 had a cross-sectional area of about 0.13 m² and a total equipment area of about 1.56 m².

The device was used to simulate the evaporation experiment of fresh water. The experiment results are shown in

TABLE 9
Example 9. Experiment Results of Evaporation Device in a Plateau Region.

| Experiment | Blower | | Environment | Environment | Liquid | Experiment | Evaporated | Evaporation | Blower energy |
|---|---|---|---|---|---|---|---|---|---|
| No. | power | | temperature | humidity | temperature | time | weight | speed | consumption |
| — | W | | ° C. | RH % | ° C. | h | Kg | Kg/h | Kwh/kg |
| | Evaporation device 1 | | | | | | | | |
| 91 | 0 | Night | 11.0 | 29 | 7.4 | 9 | 1.20 | 0.133 | 0.000 |
| | | Daytime | 13.0 | 18 | 8.5 | 12 | 2.79 | 0.233 | 0.000 |
| 92 | 2 | Night | 12.4 | 35 | 7.6 | 10 | 3.63 | 0.363 | 0.006 |
| | | Daytime | 14.6 | 25 | 8.9 | 16 | 10.01 | 0.626 | 0.003 |
| 93 | 7.7 | Night | 16.7 | 40 | 11.0 | 14 | 9.00 | 0.643 | 0.012 |
| | | Daytime 1 | 18.5 | 35 | 11.3 | 6 | 4.61 | 0.768 | 0.010 |
| | | Daytime 2 | 16.5 | 20 | 8.2 | 10 | 9.87 | 0.987 | 0.008 |
| 94 | 27 | Night | 10.5 | 35 | 5.6 | 12 | 9.56 | 0.797 | 0.034 |
| | | Daytime 1 | 12.5 | 22 | 7.0 | 12 | 11.23 | 0.936 | 0.029 |
| | | Daytime 2 | 13.5 | 10 | 7.1 | 5 | 6.43 | 1.286 | 0.021 |
| | Evaporation device 2 | | | | | | | | |
| 95 | 0 | Night | 12.8 | 22 | 9.4 | 12 | 0.55 | 0.045 | 0.000 |
| | | Daytime | 14.0 | 17 | 9.8 | 12 | 1.00 | 0.083 | 0.000 |
| 96 | 2 | Night | 14.5 | 27 | 7.3 | 10 | 2.51 | 0.251 | 0.008 |
| | | Daytime | 16.4 | 20 | 8.3 | 16 | 5.47 | 0.342 | 0.006 |
| 97 | 7.7 | Night | 13.0 | 27 | 5.5 | 11 | 4.40 | 0.400 | 0.019 |
| | | Daytime | 14.0 | 20 | 6.1 | 16 | 7.61 | 0.476 | 0.016 |

In the experiments, the daytime was from 9:00 to 21:00 Beijing time and the night was from 21:00 to 9:00 Beijing time. The time periods above would be prolonged or shortened according to the real-time changes in temperature and humidity.

The daytime data shows that the evaporation speeds of fresh water in Experiments 92, 93 and 94 are increased respectively by 2.7, 3.3 (4.2) and 4.0 (5.5) times higher than that of Experiment 91. The night data of the evaporation device 1 has the same pattern with that of the evaporation device 2. It indicates that the method and device of the present disclosure are still effective in the plateau region and can greatly improve the evaporation efficiency of liquid.

In Example 8, the evaporation speed of liquid was influenced by ambient temperature, humidity, liquid temperature, blower power and other factors, which was in the same pattern as that in Examples 1 to 5 of the present disclosure. It indicates that the method of the present disclosure is widely applicable.

In Experiment 94, the evaporation rate of fresh water was 1.286 kg/h at a low temperature (ambient temperature 13.5° C., humidity 10%), which was close to the experiment result 1.535 kg/h of the device at a normal temperature (Experiment 74, ambient temperature 31° C., humidity 53%). It indicates that the method and device of the present disclosure have obvious effect at a low temperature. In practical application, the method and device of the present disclosure can reduce requirements on the temperature in a factory building, reduce energy supplement and loss. The method and device of the present disclosure can quickly improve the evaporation efficiency of liquid at a low temperature by controlling ambient humidity, and thus have a more promising industrial application prospect.

The plateau salt-lake regions have low ambient temperature and low relative air humidity. The method and the device of the present disclosure are especially suitable for such regions and can be used to promote the evaporation of brine in salt lakes, thereby improving the mining efficiency of salt lakes and realizing industrial production in the salt-lake regions.

1-15. (canceled)

16. A method for accelerating evaporation of brine in a plateau salt lake, comprising:
introducing a downward wind to a brine surface;
changing the downward wind to a transversal wind horizontally flowing outward when the wind contacts with the brine surface, to accelerate the evaporation of the brine.

17. The method according to claim 16, wherein an angle formed by the downward wind and the brine surface ranges from 45° to 90°, preferably from 60° to 90°.

18. The method according to claim 16, wherein the downward wind has a wind speed not lower than 3 m/s, preferably has a wind speed not less than 4 m/s, and more preferably has a wind speed of from 5 m/s to 15 m/s.

19. The method according to claim 17, wherein the downward wind has a wind speed not lower than 3 m/s, preferably has a wind speed not less than 4 m/s, and more preferably has a wind speed of from 5 m/s to 15 m/s.

20. The method according to claim 16, further comprising a step of collecting an exchanged wind for a water-collecting treatment.

21. The method according to claim 20, wherein the exchanged wind is collected for the water-collecting treatment by arranging a wind deflector above the brine surface.

22. A device for accelerating evaporation of brine, comprising a central wind duct,
wherein a flow channel is gradually-lowered arranged around the central wind duct and is provided with a brine inlet and a brine outlet,
wherein a gap for ventilation is arranged between the flow channel at an upper layer and the flow channel at a lower layer;
wherein a downward wind outlet is arranged at a side wall of the central wind duct, and is provided with a wind baffle for making the wind flow downward to the surrounding flow channel.

23. The device according to claim 22, wherein the flow channel is spirally arranged outside the central wind duct, or is spirally arranged outside the central wind duct in a stepped mode.

24. The device according to claim 22, wherein the flow channel is provided with an overflow plate.

25. The device according to claim 22, wherein the flow channel is provided with an exhaust device outside.

26. A device for accelerating evaporation of brine, comprising a support provided with a downward wind outlet.

27. The device according to claim 26, wherein the support is further provided with a wind deflector surrounding the downward wind outlet.

28. The device according to claim 26, wherein a plurality of buoys is arranged under the support to keep the support floating.

29. The device according to claim 28, wherein the support is further provided with an anchor.
